(19) United States
(12) Patent Application Publication
(10) Pub. No.: US 2006/0151435 A1
(43) Pub. Date: Jul. 13, 2006

(54) Surface processing method

(76) Inventor: Jun Taniguchi, Chiba (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/528,480

(22) PCT Filed: Sep. 18, 2003
(86) PCT No.: PCT/JP03/11903

§ 371 Date: Oct. 25, 2005

Related U.S. Application Data
(60) Provisional application No. 60/412,457, filed on Sep. 19, 2002.

(30) Foreign Application Priority Data
Sep. 18, 2002 (JP) 2002-271337
Mar. 17, 2003 (JP) 2003-072318

(51) Int. Cl. C03C 15/00

(52) U.S. Cl. 216/87

(57) ABSTRACT

This invention relates to an efficient surface processing method.

In one embodiment of the invention, a laminated body 4 comprising a sample material 1, an intermediate layer 2 formed on a surface of the sample material 1, and an SOG layer 3 formed on the surface of the intermediate layer 2 is used. First, the surface of the SOG layer 3 is irradiated with an electron beam so as to expose part of the SOG layer. Next, exposed parts 31 of the SOG layer 3 are eliminated by etching. As a result, finely detailed unevenness can be formed at the surface of the SOG layer 3.

The depth of the exposed parts 31 can be controlled by changing the acceleration voltage of the electron beam. It is therefore possible to form three-dimensional shapes of different depths.

After forming unevenness at the surface of the SOG layer 3, the intermediate layer 2 and the sample material 1 can be eliminated in order using, for example, an oxygen ion beam. As a result, the same unevenness as at the surface of the SOG layer 3 can be formed at the surface of the sample material 1.

### TECHNICAL FIELD

The present invention relates to a surface processing method.

### BACKGROUND ART

As semiconductors become more finely detailed, efforts are being made to advance lithography technology in order to replace conventional semiconductor lithography technology. One such attempt is Nano Imprint Lithography (NIL). This is technology enabling manufacturing to design rules in the order of nanometers. This technology is described in detail below with reference to non-patent document 1. To outline this process, a mold with a nanometer-sized pattern drawn on is pressed on resist on an Si wafer so that the mold is transferred, thus forming a microscopic pattern. In this process, a thermoplastic resin is used as the resist material. First, the resist is heated up to a temperature above the glass transition point and the mold is then pressed against the resist. In this state, the resist is then hardened as a result of the temperature falling. The mold is then peeled away. As a result of this, it is possible to obtain a pattern on the Si wafer. However, in this process, there are problems in that having the temperature rise and fall is time consuming, production efficiency cannot be raised, and it is not possible to transfer the pattern in a reproducible manner.

A method employing photocuring resin is also provided as further lithographic technology. This method employs a transparent mold. Here, a mold is pressed against the photocuring resin and the resin is then irradiated with UV light at normal temperatures. This causes the resin to harden. The mold is then peeled away from the resin to obtain a pattern. However, in this method, it is necessary to use a photocuring resin or transparent mold. Further, it is not possible to change depth of an uneven pattern depending on the location. A related example of this type of technology is shown below.

[Related Art]

[Patent Document 1]

Japanese Patent Laid-open Publication No. 2001-68411

[Non-Patent Document 1]

S. Y. Chou, P. R. Krauss, and P. J. Renstrom: Appl. Phys. Lett. 67 (1995) 3114.

[Problems to be Solved by the Invention]

The present invention has been conceived in view of the above situation. It is one object of the present invention to provide a surface processing method capable of resolving the aforementioned problems of the related art.

### DISCLOSURE OF THE INVENTION

A surface processing method of the present invention is provided with the following steps:

(a) irradiating a surface of an SOG layer with an electron beam so as to expose at least part of the SOG layer; and

(b) removing all or part of the exposed parts of the SOG layer by etching.

A further surface processing method of the present invention employs a laminated body comprising: a sample material; an intermediate layer formed on the surface of the sample material; and an SOG layer formed on the surface of the intermediate layer. This method is provided with the following steps:

(a) irradiating a surface of the SOG layer with an electron beam so as to expose at least part of the SOG layer; and

(b) removing all or part of the exposed parts of the SOG layer by etching.

In this surface processing method, it is possible to change an accelerating voltage for the electron beam according to the irradiation position of the electron beam.

The intermediate layer can be made of PMMA or silane coupling agent.

The surface processing method employing the intermediate layer may also be provided with the following step (c).

(c) after step (b), carrying out etching using an etchant corroding the SOG layer, the intermediate layer, and the sample material, and processing the surface of the sample material and/or the intermediate layer.

A still further surface processing method of the present invention employs a laminated body comprising: a sample material; an intermediate layer formed on the surface of the sample material; and an SOG layer formed on the surface of the intermediate layer. A recess or protrusion is formed on the surface of the SOG layer. This method is provided with the following steps:

(a) carrying out etching using an etchant corroding the SOG layer, the intermediate layer, and the sample material, and forming an uneven surface on the sample material and/or the surface of the intermediate layer.

In this surface processing method, the etchant can be an etchant that corrodes the intermediate layer and/or the sample material more easily than the SOG layer.

In this surface processing method, the sample material may be any of diamond, SiC, quartz, and resin.

In this surface processing method, the etchant may be an ion beam or radiated light.

In this surface processing method, the recess or protrusion at the surface of the SOG layer can be formed by pushing a mold against the SOG layer.

The recess or protrusion at the surface of the SOG layer can be formed by the aforementioned surface processing method.

The surface formed by this method can be employed as a mold for molding.

A particulate fixing method of the present invention is provided with the following steps:

(a) irradiating a surface of the SOG layer with an electron beam so as to expose at least part of the SOG layer mixed with particulate; and

(b) removing part or all of an exposed portion of the SOG layer by etching so as to expose the particulate at the surface of the SOG layer or bring the particulate close to the surface.

In this fixing method, the SOG layer is formed on a sample material or on a surface of an intermediate layer formed on the surface of the sample material.

In this fixing method, it is possible to change an accelerating voltage for the electron beam according to the irradiation position of the electron beam.

In this fixing method, the intermediate layer can be made of PMMA or silane coupling agent.

In this fixing method, the particulate may be any of carbon nanotube, diamond powder and metallic microparticles

With the molded article of the present invention, forming takes place using a surface processed using the above-described processing method.

The surface processing method of the present invention may also be configured so that an aspect ratio of the uneven surface is adjusted after processing of the sample material and/or the intermediate layer by changing the thickness of the intermediate layer.

The laminated body of the present invention comprises: a sample material; an intermediate layer formed on the surface of the sample material; and an SOG layer formed on the surface of the intermediate layer.

The sample material of this laminated body may be any of, for example, diamond, SiC, quartz, and resin.

The intermediate layer of the laminated body may be, for example, PMMA or silane coupling agent.

In the laminated body manufacturing method of the present invention, an intermediate layer can be formed on a surface of a sample material and an SOG layer can be formed on a surface of the intermediate layer.

In this surface processing method, the ion beam may be an oxygen ion beam.

A surface processing method of the present invention employing a laminated body having a sample material and an SOG layer, with the SOG layer being arranged on one side of the sample material, may also comprise the steps of:

(a) exposing the sample material by partially eliminating or forming the SOG layer; and

(b) processing the exposed sample material by etching.

A surface processing method of the present invention employing a laminated body having a sample material, an intermediate layer, and an SOG layer, with the intermediate layer being arranged between the sample material and the SOG layer, may comprise the steps of:

(a) exposing the sample material or the intermediate layer by partially eliminating or forming the SOG layer; and

(b) processing the exposed sample material or intermediate layer by etching.

These surface processing methods may further comprise a step of:

(c) eliminating remaining SOG layer after step (b).

In this surface processing method, applied voltage in the vicinity of the surface can be made to change according to irradiation position of the electron beam.

In this surface processing method, depth of the portion eliminated by etching can be controlled based on electron beam dosage.

A surface processing method of the present invention may be provided with the following steps:

(a) irradiating a surface of a first SOG layer with an electron beam so as to expose at least part of the first SOG layer;

(b) forming a second SOG layer on a surface of the first SOG layer;

(c) irradiating a surface of the second SOG layer with an electron beam so as to expose at least part of the second SOG layer; and

(d) removing all or part of the exposed portions of the first and second SOG layers by etching.

A surface processing method where the portion of the second SOG layer irradiated with an electron beam is formed at a position overlapping with the portion of the first SOG layer irradiated with an electron beam can also be provided.

Moreover, in this surface processing method, the width of the electron beam-irradiated portion of the second SOG layer is narrower than the width of the electron beam irradiated portion of the first SOG layer.

A still further surface processing method of the present invention employs a laminated body having a sample material and an SOG layer. The SOG layer is arranged at a side of the sample material. This method is provided with the following steps:

(a) forming a recess or protrusion at a surface of the SOG layer by partially eliminating or forming the SOG layer; and

(b) processing the sample material from a surface side of the SOG layer by etching.

A still further surface processing method of the present invention employs a laminated body having a sample material, an intermediate layer, and an SOG layer. The intermediate layer is arranged between the sample material and the SOG layer. This method is provided with the following steps:

(a) forming a recess or protrusion at a surface of the SOG layer by partially eliminating or forming the SOG layer; and

(b) processing the intermediate layer or the sample material from a surface side of the SOG layer by etching.

A still further surface processing method of the present invention employs a laminated body having a sample material and a mask layer formed on a surface side of this sample material. A recess or protrusion can be formed on the surface of the mask layer. This method may be further provided with the following step:

(a) etching from the side of the mask layer using an etchant corroding the mask layer and the sample material so as to process the surface of the sample material.

In this surface processing method, silicone rubber layer can be used in place of the SOG layer. Similarly, first and second silicone rubber layers can be used in place of the first and second SOG layers.

In this particulate fixing method, silicone rubber can be used in place of the SOG layer.

In this molded article, silicone rubber layer can be used in place of the SOG layer.

In this laminated body, silicone rubber layer can be used in place of the SOG layer.

In this laminated body manufacturing method, silicone rubber layer can be used in place of the SOG layer.

A surface refining method of the present invention employs a laminated body having a sample material and a mask layer formed on a surface side of this sample material. In this method, the surface of the mask is irradiated with an electron beam and at least part of the mask layer is exposed and refined.

In this refining process, the mask layer can be made from, for example, SOG.

In this refining process, the mask layer can be made from, for example, silicone rubber.

In this refining method, the electron beam is, for example, irradiated towards the laminated body. The depth of the refined portion of the mask layer can, for example, be controlled by adjusting the potential on the side of the laminated body.

The depth of the refined portion of the mask layer can, for example, be controlled by adjusting electron beam dosage.

In this refining method, an intermediate layer may also be provided between the main material and the mask layer.

It is also possible to laminate another mask layer onto the surface of the mask layer after refining the mask layer. After providing this laminated layer, the surface of the further mask layer is irradiated with an electron beam, and at least part of the further mask layer is exposed and refined.

According to the surface processing method of the present invention, processing of a surface can be carried out in an efficient manner.

### BRIEF DESCRIPTION OF THE DRAWINGS

FIG. 1 is a view illustrating a surface processing method of a first embodiment of the present invention, and shows a cross-section of a laminated body.

FIG. 2 is a flowchart illustrating a surface processing method of the first embodiment of the present invention.

FIG. 3 is a view illustrating a surface processing method of a second embodiment of the present invention, and shows a cross-section of a laminated body.

FIG. 4 is a view illustrating a surface processing method of a third embodiment of the present invention, and shows a cross-section of a laminated body.

FIG. 5 is a view illustrating a surface processing method of a fourth embodiment of the present invention.

FIG. 6 is a view illustrating a particulate fixing method of a fifth embodiment of the present invention, and shows a cross-section of a laminated body.

FIG. 7 is a view showing results of a practical example of a sixth embodiment of the present invention, with the vertical axis indicating depth, and the horizontal axis showing distance.

FIG. 8 is a further view showing results of the practical example of the sixth embodiment of the present invention, with the vertical axis indicating depth, and the horizontal axis showing distance.

FIG. 9 is another view showing results of the practical example of the sixth embodiment of the present invention, with the vertical axis indicating depth, and the horizontal axis showing distance.

FIG. 10 is a view showing results of the practical example of a seventh embodiment of the present invention, with the vertical axis indicating depth, and the horizontal axis showing distance.

FIG. 11 is a further view showing results of the practical example of the seventh embodiment of the present invention, with the vertical axis indicating depth, and the horizontal axis showing distance.

FIG. 12 is a graph showing the relationship between developing time and SOG etching depth.

FIG. 13 is a view illustrating a surface processing method of a ninth embodiment of the present invention, and shows a cross-section of a laminated body.

FIG. 14 is a view illustrating a surface processing method of a tenth embodiment of the present invention, and shows a cross-section of a laminated body.

FIG. 15 is a view showing results of the practical example of the tenth embodiment of the present invention, with the vertical axis indicating depth, and the horizontal axis showing distance.

FIG. 16 is a view showing results of the practical example of the tenth embodiment of the present invention, with the vertical axis indicating height of transferred projection, and the horizontal axis showing distance.

FIG. 17 is a view illustrating a surface processing method of an eleventh embodiment of the present invention, and shows a cross-section of a laminated body.

### BEST MODE FOR CARRYING OUT THE INVENTION

### First Embodiment

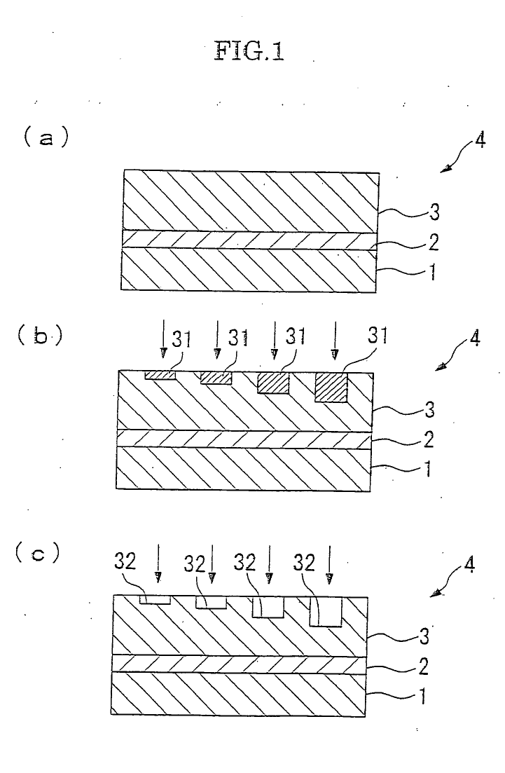

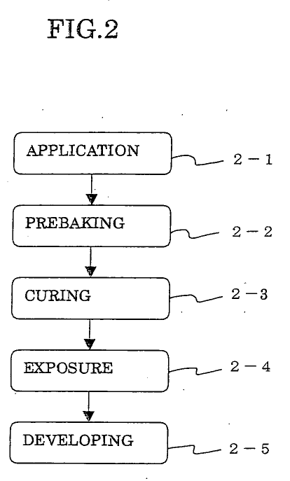

A surface processing method of a first embodiment of the present invention is described in the following with reference to FIG. 1 and FIG. 2. Here, “processing method” refers to a method of manufacturing processed matter. Further, surface processing includes forming of recesses or projections on a surface and deletion of projections formed on the surface.

First, a sample material 1 is prepared. For example, diamond, SiC, quartz, Ni, resin, glass or sapphire can be used as the sample material 1. Items having an appropriate structure such as single crystal, polycrystal, film etc. can be used as the diamond, SiC, quartz, Ni, or sapphire. Example of resin may be PTFE (polytetrafluoroethylene) and engineering plastic.

Next, an intermediate layer 2 is formed on the surface of the sample material 1. In this embodiment, PMMA (methacrylate resin) can be used as the intermediate layer 2. The intermediate layer 2 can be formed by applying and curing PMMA at the surface of the main material 1. The thickness of the intermediate layer 2 can be approximately 10 nm.

Next, an SOG (Spin-On-Glass) layer 3 is formed on the surface of the intermediate layer 2. Specifically, as shown in FIG. 2, first, SOG solvent (including methylsiloxane polymer and organic solvent) is applied to the surface of the intermediate layer 2 using spin-coating methods (step 2-1). Accuglass 512B (trademark) by Honeywell Corporation may be given as a specific example of a glass solvent. Pre-baking is then carried out for three minutes at a temperature of 80 to 250 degrees centigrade (step 2-2). Curing is then carried out in the atmosphere for one hour at a temperature of 300 degrees centigrade (step 2-3). This enables a laminated body 4 to be obtained (refer to FIG. 1(a)).

Next, the surface of the SOG layer is irradiated with an electron beam (refer to FIG. 1(b) and step 2-4 of FIG. 2). The accelerating voltage of the electron beam can be changed according to irradiation position. In this embodiment, a high accelerating voltage is adopted at the position of irradiation on the right side in FIG. 1(b). As a result, the SOG layer can be exposed (refined). In this embodiment, the exposed portion is referred to as exposed part 31. The depth of the exposed part 31 increases as the accelerating voltage is increased.

Developing (etching) is carried out using BHF (hydrofluoric acid buffer solution) as an etchant (step 2-5 of FIG. 2). BHF is a liquid mixed at HF:NH₄F=1:1. Developing time is, for example, 60 seconds. As a result, the exposed part 31 can be eliminated so as to form a recess 32 in the SOG layer 3. According to this embodiment, in this way, it is possible to form recesses and projections at the surface of the SOG layer 3.

In this embodiment, the depth of the exposed part 31 can be controlled using the magnitude of the accelerating voltage of the electron beam. The depth of the exposed part 31 can therefore be controlled in a reliable manner. It is therefore possible to reliably control the depth of the recess 32 obtained to give a multi-stepped structure. It is therefore possible to realize changes in 16 steps at a depth of 1 μm as step changes in the depth direction. Changes in 32 steps and 64 steps can also be considered possible.

Further, it is possible to focus the ion beam width to the order of 3 nm enabling processing of nano-order shapes. In reality, it is possible to form linear recesses 32 having a width of 200 nm when using an electron beam of a beam width of 100 nm. It is therefore also possible to consider forming a recess 32 having a width of less than 10 nm.

According to the method of this embodiment, it is possible to form finely-detailed uneven surfaces with good precision. As a result, finely detailed processing of MEMS and optical elements (blazed optical elements, microlens arrays, Fresnel zone plates, photonic crystal, hologram elements, digital optical elements) is possible. Further, by using the uneven surface as a mold, rather than executing the entire procedure, it is possible to obtain detailed processing by transfer.

In this embodiment, an intermediate layer 2 is formed. Wettability (adhesiveness) between the sample material 1 and the SOG layer 3 can therefore be improved. In addition, stress occurring between the sample material 1 and the SOG layer 3 (for example, stress accompanying contraction of the SOG layer 3) can be relieved.

### Second Embodiment

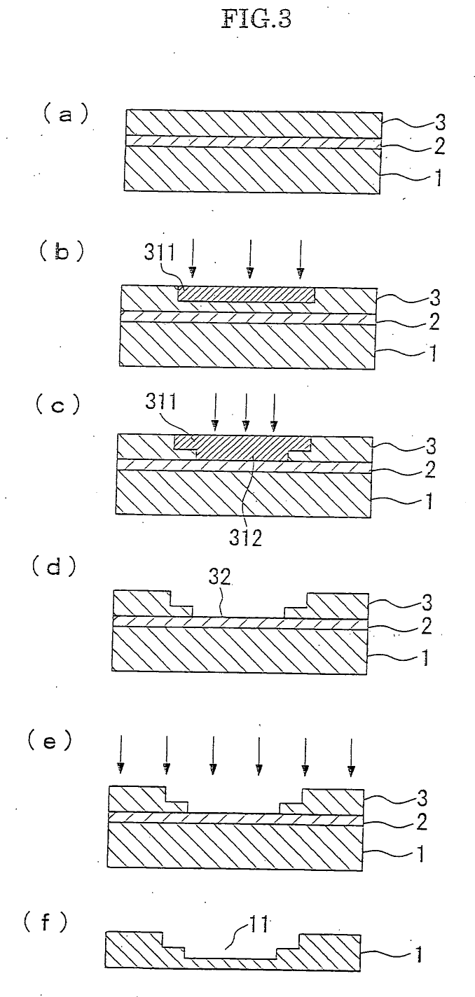

Next, a description is given with reference to FIG. 3 of a surface processing method of a second embodiment of the present invention. In this method, as with the first embodiment, first, the laminated body 4 equipped with the sample material 1, intermediate layer 2, and SOG layer 3 is formed (refer to FIG. 3(a)). Next, the SOG layer 3 is irradiated with an electron beam at an accelerating voltage of 3 kV. As a result, an exposed part 311 is formed at the SOG layer 3. Next, the SOG layer 3 is irradiated with an electron beam at a region narrower than the exposed part 311 at an accelerating voltage of 5 kV. As a result, it is possible to form an exposed part 312 that is deeper than the exposed part 311 (refer to FIG. 3(b)). The exposed parts 311 and 312 are then eliminated using BHF as an etchant (FIG. 3(c)). As a result, a recess 32 is formed at the SOG layer 3. Up to this point is fundamentally the same as for the first embodiment.

Next, in this embodiment, an oxygen ion beam generated by ECR (electron cyclotron resonance) is applied as an etchant to the surface of the SOG layer 3 (refer to FIG. 3(e)). As a result, the SOG layer 3, intermediate layer 2, and sample material 1 are corroded and are eliminated to a depth corresponding to irradiation time. As a result, a recess 11 is formed at the sample material 1 along the shape of the SOG layer 3 (refer to FIG. 3(f)). In the example shown in the drawings, all of the intermediate layer 2 is eliminated.

The SOG layer 3 is difficult to corrode with the oxygen ion beam compared to the intermediate layer 2 and the sample material 1. The method of this embodiment therefore has the advantage that it is possible to form an uneven shape of a higher aspect ratio than the uneven shape of the SOG layer 3.

In this embodiment, an oxygen ion beam is used. This means that processing is anisotropic and that there is little broadening of the processing shape. This is therefore suited to finely detailed processing.

In this embodiment, an oxygen ion beam is employed. It is therefore possible to process the SOG layer 3 in parallel with the intermediate layer 2 and the sample material 1. This means that a process to eliminate the SOG layer 3 after the event is not necessary and that processing efficiency is good.

In this embodiment, there is the advantage that finely detailed processing can be carried out in a straightforward, highly precise manner even when the sample material 1 is a hard material such as diamond, SiC, or quartz. According to this embodiment, there is the advantage that it is straightforward to make a mold for molding finely detailed shapes. Diamond is appropriate as a mold material because washing after the molding operation is easy. Further, SiC has a strong resistance to high temperatures and is therefore suited to being a material for a mold for using in molding ceramic products.

Further, it is possible to adjust the aspect ratio for forming at the surface of the sample material 1 by changing the thickness of the intermediate layer 2. Normally, processing of the sample material 1 can be considered to be completed when the SOG layer 3 is eliminated using etchant. In doing so, for example, when the intermediate layer 2 is made thick, processing of the intermediate layer 2 is time-consuming and the time for processing the sample material 1 becomes shorter by this amount. The aspect ratio of the processed surface of the sample material 1 can therefore be lowered. On the other hand, the aspect ratio of the processed surface of the sample material 1 can be made high by making the intermediate layer 2 thin.

Other aspects and advantages of the second embodiment are fundamentally the same as for the first embodiment and detailed description thereof is omitted here.

### FIRST EXAMPLE

Specific conditions under which the second embodiment can be implemented are shown in the following. Conditions described in the above embodiments are omitted.

(1) PMMA for constituting the intermediate layer 2 is applied.

Application thickness: 10 nm

(2) SOG for constituting the SOG layer 3 is applied.

Rotation speed during spin-coating: 3000 rpm

rotation time: 10 seconds

(3) Processing using oxygen ion beam employing ECR

Gas used: O₂

Ion current density: 1.35 mA/cm²

Emission current 11.0 mA

Oxygen flow rate: 3.0 sccm

Degree of vacuum: 6.67×10⁻⁴ Pa

Degree of vacuum during gas introduction: 3.18×10⁻⁴ Pa

Microwave output: 100 W

Ion beam accelerating voltage: 300V

Processing time: 30 minutes.

In the second embodiment, a recess 32 is formed at the SOG layer 3 using electron beam exposure but, for example, it is also possible to form the recess 32 by pressing a mold against the SOG layer 3.

### Third Embodiment

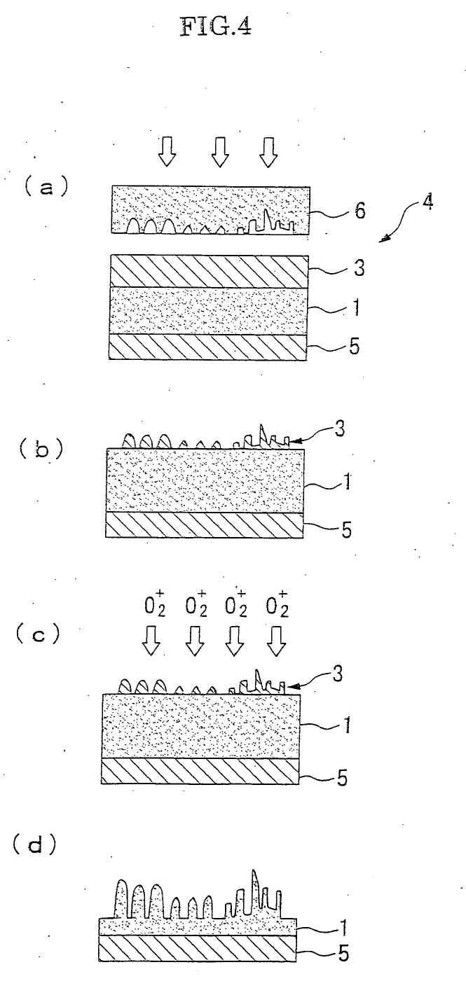

Next, a description is given with reference to FIG. 4 of a molding method of the third embodiment of the present invention. In this method, resin is used as the sample material 1. An SOG layer 3 is formed on the upper surface of the sample material 1. An intermediate layer is not formed. Foundation material 5 is used to form the sample material 1 (refer to FIG. 4(a)).

Therefore, in this embodiment, the laminated body 4 is comprised of the sample material 1, the SOG layer 3, and the base material 5. The composition of the sample material 1 and the SOG layer 3 is the same as for the first embodiment. The base material is constructed from, for example, Si or glass. A cheap material with a high degree of flatness is appropriate as the base material.

Next, a mold 6 is pressed against the surface of the aforementioned SOG layer 3. An uneven surface (mold surface) is formed using, for example, the method of the second embodiment, at the surface of the mold 6 (bottom surface in FIG. 4(a)). As a result, it is possible to transfer a mold shape to the surface of the SOG layer 3 (refer to FIG. 4(b)). The formed SOG layer 3 is then irradiated with an oxygen ion beam taken as an etchant in the same manner as for the second embodiment (refer to FIG. 4(c)). As a result, it is possible to process the SOG layer 3 and the sample material 1 along the shape of the SOG layer 3 (refer to FIG. 4(d)). It is possible to make the aspect ratio of the processed surface of the sample material 1 higher than that of the SOG layer 3 by selecting a material that is more easily processed than the SOG layer 3 as the sample material 1.

In the third embodiment the uneven surface of the SOG layer 3 is formed using mold transfer but may also be formed using methods employing electron beam exposure and development (elimination of exposed parts) as shown in the first and second embodiments.

Other aspects and advantages of the third embodiment are the same as for the first and second embodiments and description thereof is omitted.

### Fourth Embodiment

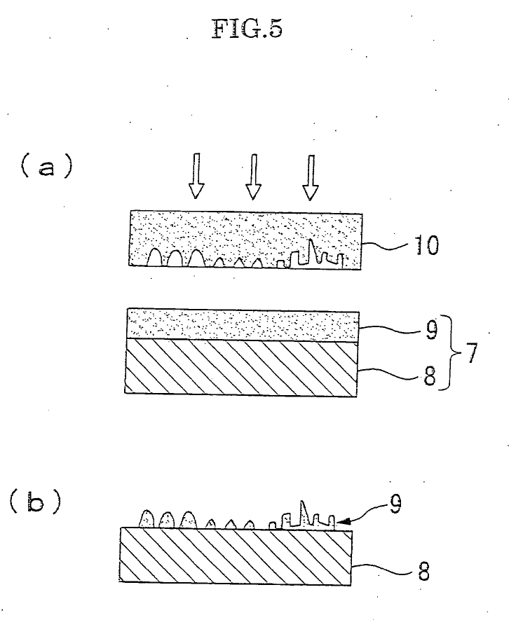

Next, a description is given with reference to FIG. 5 of a fourth embodiment of the present invention. This embodiment relates to a molding method employing an uneven surface obtained using a method of each of the embodiments. First, a product to be molded 7 is positioned. The material of the product to be molded 7 is arbitrary but in this embodiment this may be, for example, an appropriate base material 8 and a main body 9 formed on the surface of the base material 8. For example, PTFE, engineering plastic, PMMA, or a resin such as an acrylic resin, etc., or a soft metal such as Al, etc. can be used as the main body 9. In the case of using a soft metal such as Al, an optical element used in reflection such as a diffraction grating blazed optical element etc. can be obtained through mold-pressing. It is possible to obtain a hologram at once by press-molding the soft-metal. On the other hand, the uneven surface if obtained at the lower surface of a mold 10 using one of the processing methods of the above embodiments.

Next, the uneven shape is transferred by pressing the lower surface of the mold 10 against the main body 9. As a result, it is possible to easily obtain a miniature molded product used in, for example, MEMS or optical elements.

### Fifth Embodiment

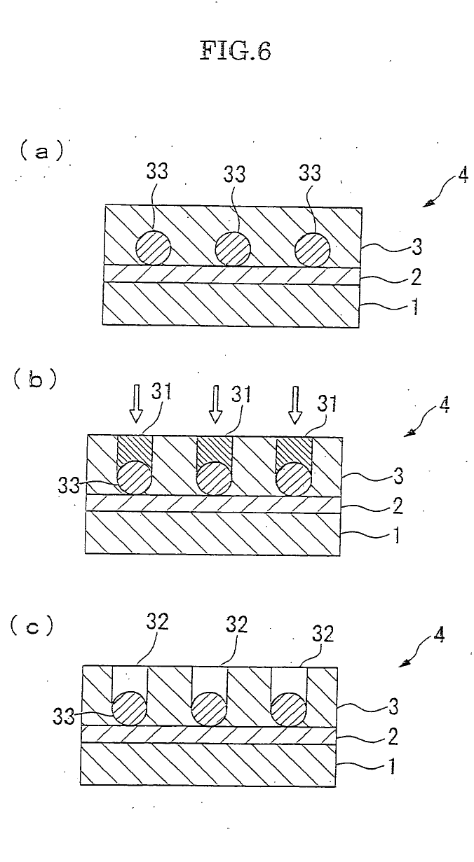

Next, a description is given with reference to FIG. 6 of a fifth embodiment of the present invention. This embodiment, as in the first and second embodiment, employs a laminated body 4 equipped with the sample material 1, intermediate layer 2, and SOG layer 3. However, in the fifth embodiment, particulate 33 is mixed into the SOG layer 3 (refer to FIG. 6(a)). In this embodiment, the position of the particulate 33 is set in advance. The position of the particulate 33 is then irradiated with an electron beam. In this embodiment, the accelerating voltage of the electron beam is taken to be a voltage capable of bringing about exposure due to the electron beam as far as the surface of the particulate 33. In this way, the exposed parts 31 are formed (refer to FIG. 6(b)).

Next, exposure is carried out using BHF as an etchant and recesses 32 are formed (refer to FIG. 6(c)). As a result, the SOG covering the particulate is eliminated and the particulate is exposed to the outside. As described above for the first embodiment, the depth of the recesses 32 can be changed by changing the accelerating voltage of the electron beam. The depth of the recesses 32 can also be made to be an extent that does not expose the particulate 33 to the outside (to an extent that the particulate 33 is in the vicinity of the surface of the SOG layer 3) by adjusting the accelerating voltage of the electron beam.

According to this embodiment, in this way, the particulate can be fixed in a state exposing the particulate to the outside. For example, carbon nanotube, diamond powder and metallic microparticles (including the case of a mixture of these) can be used as the particulate. In this case, the fixed particulate 33 can be utilized as an electrode for FED (Field Emission Display) use.

### Sixth Embodiment

Next, a description is given of a surface processing method of a sixth embodiment of the present invention. In this method, as with the first embodiment, first, the laminated body 4 equipped with the sample material 1, intermediate layer 2, and SOG layer 3 is formed. Next, the SOG layer 3 is irradiated with an electron beam at an appropriate accelerating voltage (for example, 2 kV). In this embodiment, voltage in the vicinity of the surface to which it is applied is changed according to irradiation position of the electron beam. More specifically, at a sample table (not shown) where the laminated body 4 is arranged, a voltage for changing an electric field applied in space from the electron gun to the sample table is applied. Further, this voltage is changed according to the position of irradiation of the electron beam. The applied voltage may be a negative or positive voltage. Namely, the applied voltage may make the electric field stronger or weaker.

Next, the exposed parts are eliminated in the same manner as for the first embodiment. As a result, recesses can be formed at the SOG layer 3.

According to the sixth embodiment, the depth of the exposed parts, i.e. the depth of the recesses formed, can be controlled by changing the voltage on the sample table side. In the case of changing the accelerating voltage on the electron gun side, irradiation position of the electron beam can be changed using the influence of deflectors etc. existing midway, and positioning of the electron beam becomes necessary. According to this embodiment, this kind of positioning is not necessary and control of the depth of the recessions can be achieved in a straightforward manner.

### SECOND EXAMPLE

Experimental Conditions

Electron gun accelerating voltage: fixed (2 kV)

Sample table-side voltage: Changed from 0 to −1.5 kV

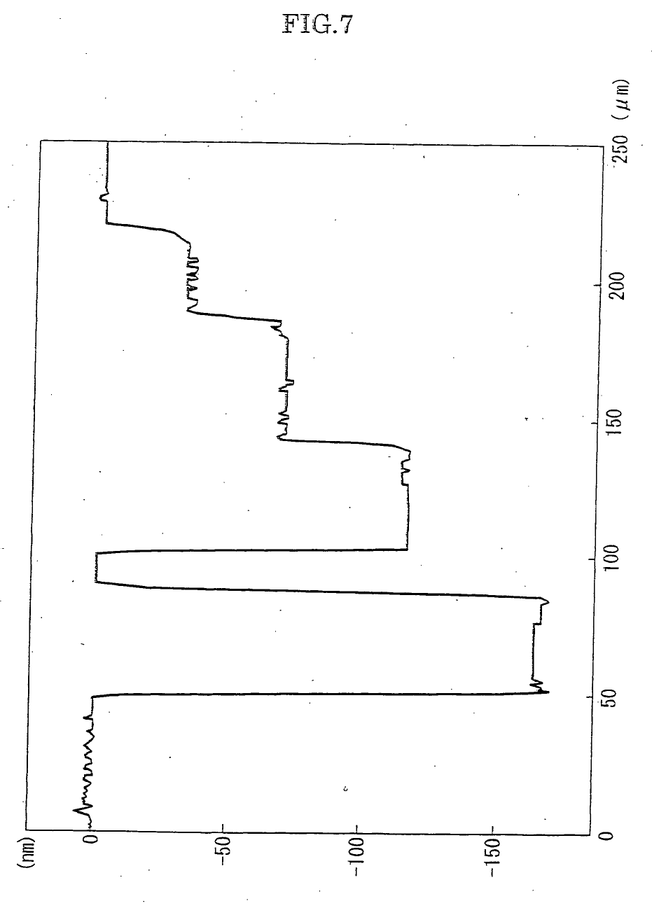

Recesses were formed using the method of the sixth embodiment under these conditions. Results are shown in the following table 1. Further, the shapes of recesses formed to different depths are shown in FIG. 7. It can be understood that the depth can be made shallow by reducing the voltage on the sample table-side. The voltage applied and depth formed to have a substantially proportional relationship and superior control can therefore be obtained.

TABLE 1

| | | | | |
|---|---|---|---|---|
| Electron gun | 2 | 2 | 2 | 2 |
| side | | | | |
| accelerating | | | | |
| voltage | | | | |
| Sample table | 0 | −0.5 | −1.0 | −1.5 |
| voltage (kV) | | | | |
| Anticipated | 2 | 1.5 | 1 | 0.5 |
| voltage (kV) | | | | |
| Elimination | 166 | 116 | 71 | 35 |
| depth (nm) | | | | |

### THIRD EXAMPLE

Experimental Conditions

Electron gun accelerating voltage: fixed (2 kV)

Sample table-side voltage: Changed from 0 to +1.0 kV

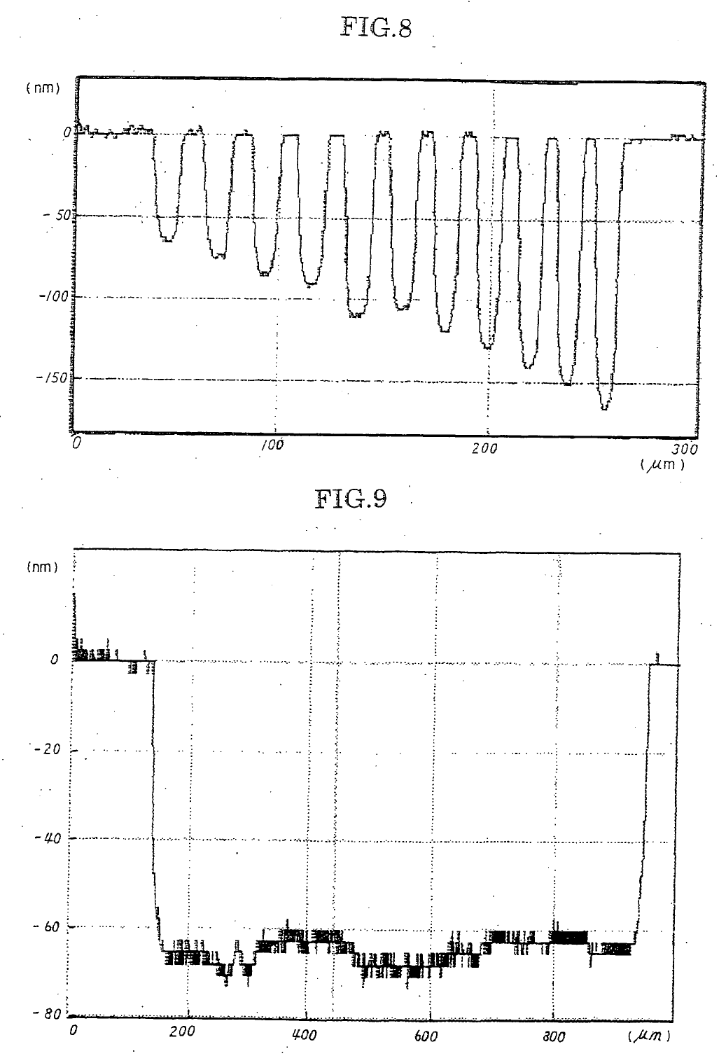

Recesses were formed using the method of the sixth embodiment under these conditions. Results are shown in the following table 2. Further, the shapes of recesses formed to different depths are shown in FIG. 8. It can be understood that the depth can be made deeper by increasing the voltage on the sample table-side. The voltage applied and depth formed to have a substantially proportional relationship and superior control can therefore be obtained.

TABLE 2

| | | | | | | | | | | | |
|---|---|---|---|---|---|---|---|---|---|---|---|
| Electron gun | 1 | 1 | 1 | 1 | 1 | 1 | 1 | 1 | 1 | 1 | 1 |
| side | | | | | | | | | | | |
| accelerating | | | | | | | | | | | |
| voltage | | | | | | | | | | | |
| Following | 0. | 0.1 | 0.2 | 0.3 | 0.4 | 0.5 | 0.6 | 0.7 | 0.8 | 0.9 | 1 |
| (kV) | | | | | | | | | | | |
| Apparent | 1 | 1.1 | 1.2 | 1.3 | 1.4 | 1.5 | 1.6 | 1.7 | 1.8 | 1.9 | 2.0 |
| voltage (kV) | | | | | | | | | | | |
| SOG | 68 | 79 | 87 | 94 | 112 | 110 | 122 | 130 | 142 | 152 | 167 |
| elimination | | | | | | | | | | | |
| depth (nm) | | | | | | | | | | | |

### FOURTH EXAMPLE

Experimental Conditions

Electron gun accelerating voltage: fixed (1 kV)

Sample table-side voltage: average value taken to be the same as accelerating voltage of electron gun at 1 kV, and a 200V-amplitude sine wave is applied. Recesses were formed using the method of the sixth embodiment under these conditions. The shape of recesses formed as a result is shown in FIG. 9. It can be understood that processing is possible in the shape of a sine wave at the bottom of the recess by changing the voltage of the sample table side to a sine wave shape. It can therefore be understood that processing is possible in the shape of a curved surface at the bottom of the recess by changing the voltage of the sample table side: Changing of the voltage at the side of the sample table is not limited to a sine wave shape and can also be, for example, an arbitrary shape such as a circular arc, step-shape, or saw-tooth shape, etc. The shape of the bottom surface of the obtained recesses substantially correspond to the shape of the changing of the voltage.

### Seventh Embodiment

Next, a description is given of a surface processing method of a seventh embodiment of the present invention. In this method, as with the first embodiment, first, the laminated body 4 equipped with the sample material 1, intermediate layer 2, and SOG layer 3 is formed. Next, the SOG layer 3 is irradiated with an electron beam at an appropriate accelerating voltage (for example, 4 kV). In this embodiment, the dosage of the electron beam can be changed using the irradiation position of the electron beam.

Next, the exposed parts are eliminated in the same manner as for the first embodiment. As a result, recesses can be formed at the SOG layer 3.

According to the seventh embodiment, the depth of the exposed parts, i.e. the depth of the recesses formed, can be controlled by changing the electron beam dosage. In the case of changing the accelerating voltage on the electron gun side, irradiation position of the electron beam can be changed using the influence of deflectors etc. existing midway, and positioning of the electron beam becomes necessary. According to this embodiment, this kind of positioning is not necessary and control of the depth of the recesses can be achieved in a straightforward manner.

### FIFTH EXAMPLE

Experimental Conditions

Electron gun accelerating voltage: fixed (4 kV)

Dosage: changed between 400˜50000 μC/c m²

BHF developing time: 60 seconds

SOG layer material: USG-50 (Honeywell Corporation) constituting a silicate material.

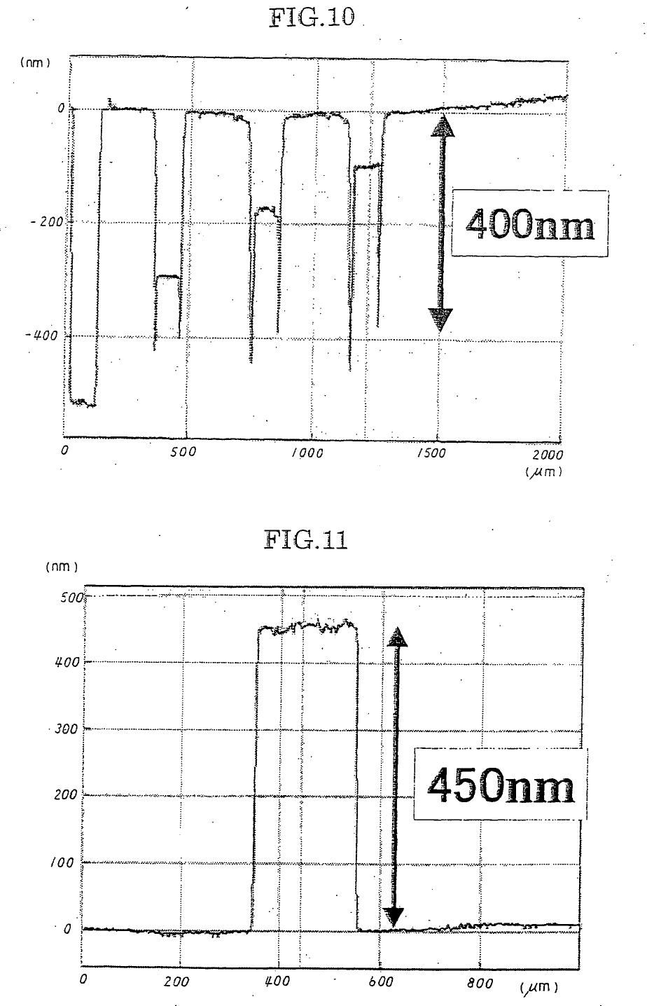

Recesses were formed using the method of the seventh embodiment under these conditions. Results are shown in the following table 3. Further, the shapes of recesses formed to different depths are shown in FIG. 10. It can be understood that depth can be controlled by changing the dosage.

TABLE 3

| | | | | |
|---|---|---|---|---|
| Dosage | 500 | 2000 | 5000 | 10000 |
| (μC/cm²) | | | | |
| depth (nm) | 500 | 300 | 200 | 100 |

In the fifth example, the development time is taken to be seven minutes in the case of a dosage of 1000 μC/c m^{2.} As a result, it is possible to form the step-shaped projection shown in FIG. 11. The reason for this can be considered to be that polymerization occurs at portions irradiated with the electron beam as a result of increasing the dosage so that etching resistance becomes greater than at non-irradiated portions.

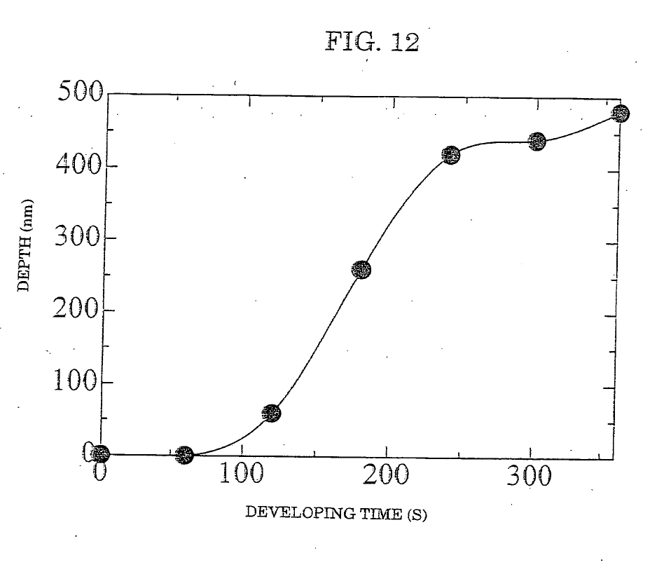

The relationship between corrosion time and corrosion depth in the case of corrosion of SOG that has not been exposed to an electron beam in an etching solution is shown in FIG. 12. If the time is approximately 60 seconds, then non-irradiated portions of the SOG are substantially not corroded. Because of this, this range is normally preferable in the case of forming recesses. On the other hand, when corrosion time is, for example, approximately 7 minutes, the non-irradiated portions are corroded deeply. If the etching resistance of portions irradiated by the electron beam is made high, as shown in FIG. 11, projections can be made to remain. Namely, a negative is formed. It can also be considered to be possible to control the appearance of this phenomenon by changing conditions such as the composition, type, and concentration etc. of the etching solution.

### Eighth Embodiment

Next, a description is given of a surface processing method of an eighth embodiment of the present invention. In this method, a silicon rubber layer is used in place of the SOG layer of the first embodiment. Therefore, in the eighth embodiment, the laminated body is formed from the sample material 1, intermediate layer 2, and silicon rubber layer 3 (refer to FIG. 3(a)). The silicone rubber layer is referred to using the same numerals as for the SOG layer. The silicone rubber is, for example, PDMS (Polydimethylsiloxane).

In this embodiment also, the SOG layer 3 is irradiated with an electron beam at an appropriate accelerating voltage (for example, 5 kV). In this embodiment, the dosage of the electron beam can be changed using the irradiation position of the electron beam. However, it is also possible to change the acceleration voltage of the electron beam using irradiation position.

Next, the exposed parts are eliminated by etching in the same manner as for the first embodiment. As a result, recesses can be formed at the silicone rubber layer 3.

According to the eighth embodiment, the depth of the exposed parts, i.e. the depth of the recesses formed, can be controlled by changing the electron beam dosage or by changing the accelerating voltage.

According to this embodiment, unevenness can be formed on silicone rubber having flexibility. It is then possible to form a miniature curved surface by pressing against a curved surface of an object taking the uneven surface as a mold. By using this method, it is possible to carry out shape processing of microscopic parts such as DNA chips and microreactors, etc.

Further, silicone rubber typically has better adhesiveness than SOG and may therefore easily be directly adhered to the sample material 1 without using the intermediate layer 2.

### SIXTH EXAMPLE

Experimental Conditions

Electron gun accelerating voltage: fixed (5 kV)

Dosage: changed between 500˜10000 μC/cm²

BHF developing time: 60 seconds

Silicone rubber layer material: PDMS

Recesses were formed using the method of the eighth embodiment under these conditions. Results are shown in the following table 4. It can be understood that depth can be controlled by changing the dosage. It can be understood that, contrary to SOG, with PDMS, the depth of elimination is greater for a larger dosage.

TABLE 4

| | | | | | |
|---|---|---|---|---|---|
| Dosage | 500 | 1000 | 2000 | 5000 | 10000 |
| (μC/cm²) | | | | | |
| depth (nm) | 1.0 | 1.5 | 2.0 | 2.5 | 3.0 |

### Ninth Embodiment

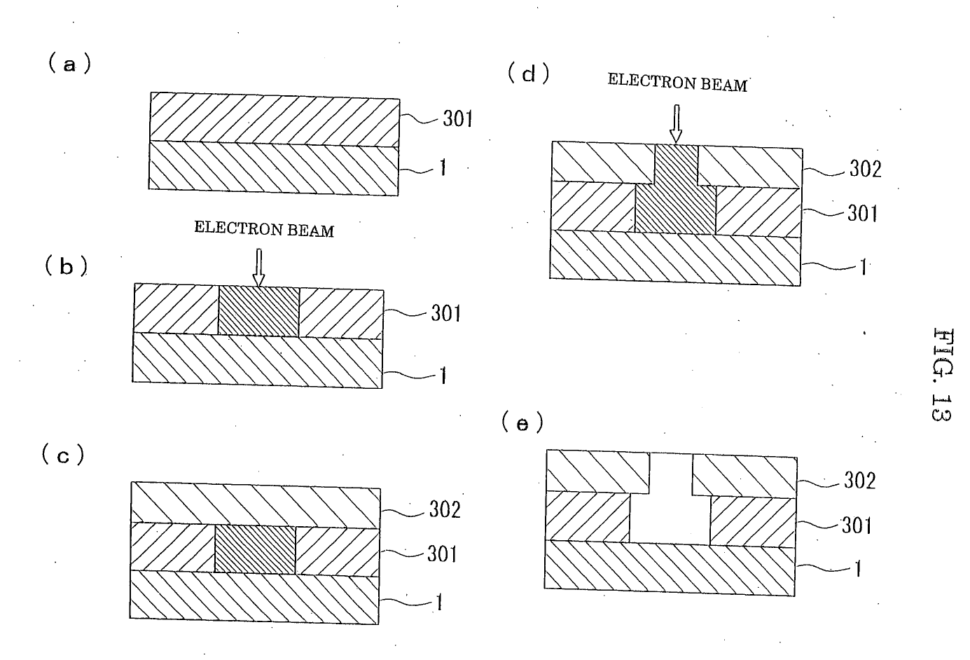

Next, a description is given based on FIG. 13 of a surface processing method of a ninth embodiment of the present invention. First, a first SOG layer 301 is formed on the surface of a silicon sample material 1 using the same method as for the first embodiment (refer to FIG. 13(a)). Next, the surface of the first SOG layer 301 is irradiated with an electron beam so as to expose part of the first SOG layer 301 (refer to FIG. 13(b)).

After this, a second SOG layer 302 is formed at the surface of the first SOG layer 301 (refer to FIG. 13(c)). Next, the surface of a second SOG layer 302 is irradiated with an electron beam so as to expose part of the second SOG layer 302 (refer to FIG. 13(d)). At this time, the accelerating voltage of the electron beam is controlled in such a manner that the part exposed by the electron beam reaches the first SOG layer 301 (i.e. passes through the second SOG layer 302). As described in the above embodiments, a method such as changing the voltage at the sample table side, or changing the dosage can also be utilized as a method for controlling the exposure depth.

In this embodiment, the electron beam-irradiated part of the second SOG layer 302 is formed at a position overlapping with the electron beam-irradiated part of the first SOG layer 301. Further, the width of the electron beam-irradiated part of the second SOG layer 302 is made to be narrower than the width of the electron beam-irradiated part of the first SOG layer 301.

Next, the portions exposed at the first and second SOG layers 301 and 302 are eliminated by etching (refer to FIG. 13(e)).

According to the method of this embodiment, as shown in FIG. 13(e), it is possible to obtain a structure having steps. Further, a microscopic channel can be formed by making the width of the electron beam-irradiated part of the second SOG layer 302 narrower than the width of the electron beam-irradiated part of the first SOG layer 301.

### Tenth Embodiment

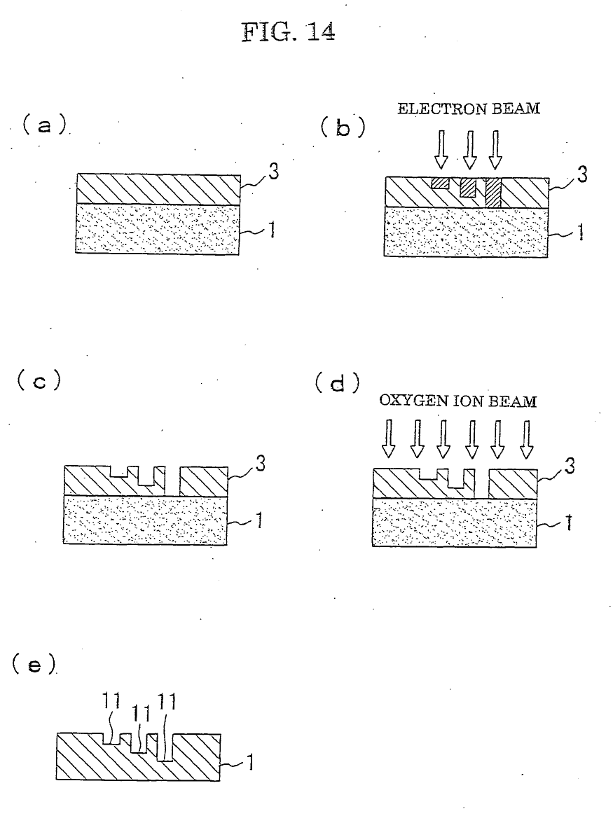

Next, a description is given based on FIG. 14 of a surface processing method of a tenth embodiment of the present invention. In this embodiment, quartz is employed as the material of the sample material 1. In this surface processing method, an SOG layer 3 is formed on the surface of the sample material 1 (refer to FIG. 14(a)). Next, the surface of the SOG layer 3 is irradiated with an electron beam so as to expose part of the SOG layer 3 (refer to FIG. 14(b)).

Next, the portion exposed at the SOG layer 3 is eliminated by etching (refer to FIG. 14(c)). Next, the surface of the SOG layer 3 is irradiated taking an oxygen ion beam as an etchant (refer to FIG. 14(d)). As a result, using the same operation as for the second embodiment, a recess 11 is formed at the sample material along the shape of the SOG layer 3 (refer to FIG. 14(e)).

According to the method of this embodiment, there is the advantage that microscopic unevenness can be formed on quartz that is harder than SOG. As a result, it is possible to obtain a durable microscopic mold.

### SEVENTH EXAMPLE

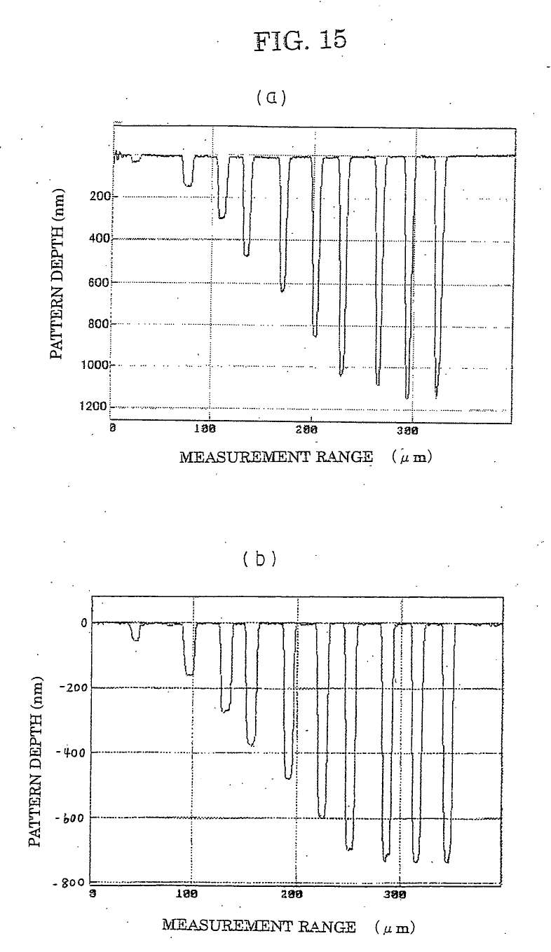

In a method of a tenth embodiment, first, recesses are formed at an SOG layer 3. The result of this is shown in FIG. 15(a). Continuing on, an oxygen ion beam is irradiated in accordance with the aforementioned method under the following conditions.

Experimental Conditions

Base degree of vacuum: 10⁻⁴ torr or less

Degree of vacuum (average) during processing: 1.93×10⁻² torr

Microwave output: 100 W

Accelerating voltage: 300V

Ion emission (average): 10.6 mA

Current density (average): 0.48 A/cm²

Processing time: 90 minutes.

As a result, it is possible to form the kind of recesses shown in FIG. 15(b) at the surface of the sample material 1.

Further, it is possible to carry out transfer of shapes by using recesses formed in this manner as a mold. The transfer conditions are as follows.

(Transfer Conditions)

Resin used (object): acrylic hardening resin

Transfer pressure: 50 N/cm²

Ultraviolet irradiation dosage: 1 J/cm²=118 mW/cm²×8.47 s

In this transfer, after pressing the resin with the mold so as to cause deformation, the resin is cured through irradiation with ultra-violet rays. After this, the mold is released and the transfer is complete.

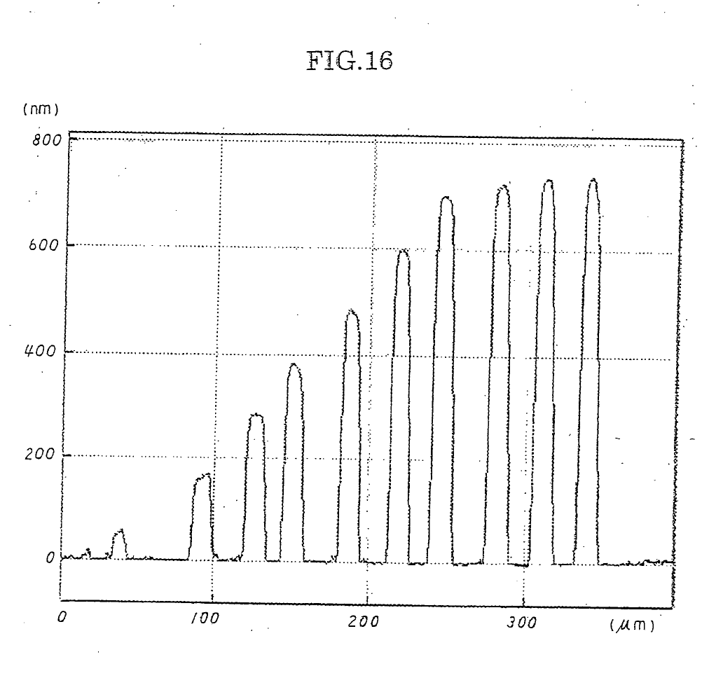

As a result, as shown in FIG. 16, it is possible to transfer unevenness to the surface of resin.

### Eleventh Embodiment

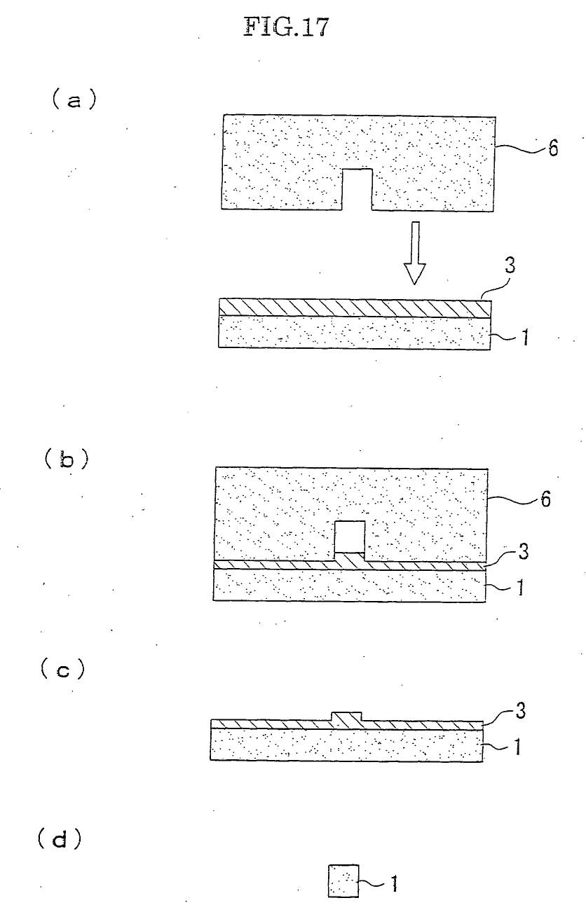

Next, a description is given based on FIG. 17 of a surface processing method of an eleventh embodiment of the present invention. In the method of this embodiment, diamond is employed as the material of the sample material 1. Further, in this method, a mask layer 3 is formed at the surface of the sample material 1. For example, Al is used as the material for the mask layer 3, but other materials such as, for example, SOG can also be used. First, the mold 6 is pressed against the mask layer 3 (refer to FIGS. 17(a) and (b)). Next, the mold 6 is separated from the mask layer 3 (refer to FIG. 17(c)). As a result, a projection can be formed at the mask layer 3. Next, the surface of the mask layer 3 is irradiated with etchant (for example, oxygen plasma or oxygen ions). As a result, it is possible to form a cross-section sample for the sample material 1 (refer to FIG. 17(d)).

As a result, it is possible to make a TEM (Transmission Electron Microscope) cross-section sample in a relatively straightforward manner. It is also possible to make a cross-section sample with a high aspect ratio by employing an etchant that processes the body sample more quickly than the mask layer.

In embodiment, an example is shown of a processing method utilizing an oxygen ion beam but, for example, oxygen RIE (Reactive Ion Etching) can also be used in place of oxygen ion etching. In the case of using oxygen RIE, it is not possible to eliminate an SOG layer and it is therefore necessary to use BHF separately in order to eliminate the SOG layer. The method in this case is such that, after the SOG layer is partly eliminated and the intermediate layer or the sample material is exposed, the sample material (and when an intermediate layer is provided, the intermediate layer) is processed using oxygen RIE and the remaining SOG layer is then eliminated.

Further, radiated light may also be used as etchant in place of the oxygen ion beam. When radiated light is used, it is possible to eliminate the SOG layer using this radiated light. A process employing radiated light has the benefits of:

(1) Convenient operation because the SOG layer 3 and the sample material 1 can be processed at the same time.

(2) Highly precise processing can be achieved because the radiated light broadens even less than an oxygen ion beam.

(3) Processing speed for SOG is usually slower than for sample material 1 such as resin etc. and it is therefore possible to adopt a higher aspect ratio for the uneven shape of the sample material than for the uneven shape of the SOG layer 3.

Further, other ion beam may also be used as etchant in place of the oxygen ion beam. For example, an argon, CF₄CHF₃ ion beam etc. can also be used when the sample material 1 is glass or sapphire. In this case, it is possible to form the uneven shape formed at the SOG layer 3 at 1:1 using, for example, the method of the second embodiment or third embodiment, so as to make production of a precisely processed product substantially more straightforward.

Further, the processing method of the above embodiments can be used to make metal masters and stampers for CDs and DVDs. Moreover, the processing methods of the above embodiments can be used to make stencil masks for use in LEEPL (Low Energy Electron beam Projection Lithography) and EPL (Electron Projection Lithography).

The above described embodiments and practical examples are merely given as examples and in no way show indispensable configurations of the present invention. Each part of the configuration is not limited to that stated above providing that the essential essence of the present invention is achieved.

Further, silane coupling agent (a material having an organic functional group and a hydrolysis group in one molecule) can also be used as the intermediate layer 2 in place of the PMMA. When a silane coupling agent is employed, binding of organic resin and inorganic matter is improved. It is therefore possible to increase adhesiveness of the sample material 1 and the SOG layer 3 when organic resin is used as the sample material 1. It is also possible to omit the intermediate layer 2.

### DESCRIPTION OF THE NUMERALS

1 sample material
11 recess
2 intermediate layer
3 SOG layer (mask layer, silicone rubber layer)
301 first SOG layer (mask layer)
302 second SOG layer (other mask layer)
31, 311, 312 exposed parts
32 recesses
33 particulate
4 laminated body
5, 8 base material
6, 10 mold
7 product to be molded
8 sensor body
9 body

1. A surface processing method comprising the steps of:
(a) irradiating a surface of an SOG layer with an electron beam so as to expose at least part of the SOG layer; and
(b) removing all or part of the exposed parts of the SOG layer by etching.

2. A surface processing method employing a laminated body having a sample material; an intermediate layer formed on a surface of the sample material, and an SOG layer formed on a surface of the intermediate layer, the method comprising the steps of:
(a) irradiating the surface of the SOG layer with an electron beam so as to expose at least part of the SOG layer; and
(b) removing all or part of the exposed parts of the SOG layer by etching.

3. The surface processing method of claim 1, wherein an accelerating voltage for the electron beam is changed according to an irradiation position of the electron beam.

4. The surface processing method of claim 2, wherein the intermediate layer is made from PMMA or silane coupling agent.

5. The surface processing method of claim 2, further comprising a step of:
(c) after step (b), carrying out etching using an etchant corroding the SOG layer, the intermediate layer, and the sample material, and processing the surface of the sample material and/or the intermediate layer.

6. A surface processing method employing a laminated body having a sample material; an intermediate layer formed on a surface of the sample material, and an SOG layer formed on a surface of the intermediate layer and with a recess or protrusion formed on the surface of the SOG layer, comprising a step of:
(a) carrying out etching using an etchant corroding the SOG layer, the intermediate layer, and the sample material, and forming an uneven surface on the surface of the sample material and/or the intermediate layer.

7. The surface processing method of claim 5, wherein the etchant is an etchant corroding the intermediate layer and/or the sample material more easily than the SOG layer.

8. The surface processing method as disclosed in claim 5, wherein the sample material is any of diamond, SiC, quartz, and resin.

9. The surface processing method as disclosed in claim 6, wherein the etchant is an ion beam or radiated light.

10. The surface processing method as disclosed in claim 6, wherein the recess or protrusion at the surface of the SOG layer is formed by pushing a mold against the SOG layer.

11. A surface processing method employing a laminated body having a sample material; an intermediate layer formed on a surface of the sample material, and an SOG layer formed on a surface of the intermediate layer and with a recess or protrusion formed on the surface of the SOG layer, comprising a step of:
(a) carrying out etching using an etchant corroding the SOG layer, the intermediate layer, and the sample material, and forming an uneven surface on the surface of the sample material and/or the intermediate layer,
wherein the recess or protrusion at the surface of the SOG layer is formed by a processing method disclosed in claim 1.

12. The surface processing method as disclosed in claim 1, wherein the surface formed by the processing method can be used as a mold for use in molding.

13. A method for fixing particulate comprising the steps of:
(a) irradiating a surface of an SOG layer with an electron beam so as to expose at least part of the SOG layer mixed with particulate; and
(b) removing part or all of the exposed part of the SOG layer by etching so as to expose the particulate at the surface of the SOG layer or bring the particulate close to the surface.

14. The particulate fixing method as disclosed in claim 13, wherein the SOG layer is formed on a sample material or on a surface of an intermediate layer formed on the surface of the sample material.

15. The particulate fixing method as disclosed in claim 13, wherein an accelerating voltage for the electron beam is changed according to an irradiation position of the electron beam.

16. The particulate fixing method as disclosed in claim 14, wherein the intermediate layer is made from PMMA or silane coupling agent.

17. The particulate fixing method of claim 13, wherein the particulate is any of carbon nanotube, diamond powder and metallic microparticles.

18. A molded article wherein forming takes place using a surface processed using the method disclosed in claim 1.

19. The surface processing method as disclosed in claim 6, wherein an aspect ratio of the uneven surface is adjusted after processing of the sample material and/or the intermediate layer by changing the thickness of the intermediate layer.

20. A laminated body comprising: a sample material; an intermediate layer formed on the surface of the sample material; and an SOG layer formed on the surface of the intermediate layer.

21. The laminated body of claim 20, wherein the sample material is any of diamond, SiC, quartz, and resin.

22. The laminated body as disclosed in claim 20, wherein the intermediate layer is PMMA or a silane coupling agent.

23. A laminated body manufacturing method wherein an intermediate layer is formed on a surface of a sample material and an SOG layer is formed on a surface of the intermediate layer.

24. The surface processing method as disclosed in claim 9, wherein the ion beam is an oxygen ion beam.

25. A surface processing method employing a laminated body having a sample material and an SOG layer, with the SOG layer being arranged on one side of the sample material, comprising the steps of:
(a) exposing the sample material by partially eliminating or forming the SOG layer; and
(b) processing the exposed sample material by etching.

26. A surface processing method employing a laminated body having a sample material, an intermediate layer, and an SOG layer, with the intermediate layer being arranged between the sample material and the SOG layer, comprising the steps of:
(a) exposing the sample material or the intermediate layer by partially eliminating or forming the SOG layer; and
(b) processing the exposed sample material or intermediate layer by etching.

27. The surface processing method of claim 25, further comprising a step of:
(c) eliminating remaining SOG layer after step (b).

28. The surface processing method of claim 1, wherein applied voltage in the vicinity of the surface is changed according to an irradiation position of the electron beam.

29. The surface processing method as disclosed in claim 1, wherein depth of the portion eliminated by etching is controlled based on electron beam dosage.

30. A surface processing method comprising the steps of:
(a) irradiating a surface of a first SOG layer with an electron beam so as to expose at least part of the first SOG layer;
(b) forming a second SOG layer on a surface of the first SOG layer;
(c) irradiating a surface of the second SOG layer with an electron beam so as to expose at least part of the second SOG layer; and
(d) removing all or part of the exposed portions of the first and second SOG layers by etching.

31. The surface processing method as disclosed in claim 30, wherein the portion of the second SOG layer irradiated with an electron beam is formed at a position overlapping with the portion of the first SOG layer irradiated with an electron beam.

32. The surface processing method as disclosed in claim 30, wherein the width of the portion of the second SOG layer irradiated with an electron beam is narrower than the width of the portion of the first SOG layer irradiated with an electron beam.

33. A surface processing method employing a laminated body having a sample material and an SOG layer, with the SOG layer being arranged on one side of the sample material, comprising the steps of:
(a) forming a recess or protrusion at a surface of the SOG layer by partially eliminating or forming the SOG layer; and
(b) processing the sample material from a surface side of the SOG layer by etching.

34. A surface processing method employing a laminated body having a sample material, an intermediate layer, and an SOG layer, with the intermediate layer being arranged between the sample material and the SOG layer, comprising the steps of:
(a) forming a recess or protrusion at a surface of the SOG layer by partially eliminating or forming the SOG layer; and
(b) processing the intermediate layer or the sample material from a surface side of the SOG layer by etching.

35. A surface processing method, employing a laminated body having a sample material and a mask layer formed on a surface side of this sample material formed with a recess or a protrusion at a surface of the mask layer, comprising a step of:
(a) etching from the side of the mask layer using an etchant corroding the mask layer and the sample material so as to process the surface of the sample material.

36. The surface processing method as disclosed in claim 1, wherein a silicone rubber layer is used in place of the SOG layer.

37. The surface processing method as disclosed in claim 30, wherein first and second silicone rubber layers are used in place of the first and second SOG layers.

38. The particulate fixing method as disclosed in claim 13, wherein a silicone rubber layer is used in place of the SOG layer.

39. Molded matter as disclosed in claim 18, wherein a silicone rubber layer is used in place of the SOG layer.

40. The laminated body as disclosed in claim 20, wherein a silicone rubber layer is used in place of the SOG layer.

41. A method for manufacturing a laminated body as disclosed in claim 23, wherein a silicone rubber layer is used in place of the SOG layer.

42. A surface refining method, employing a laminated body having a sample material and a mask layer formed on a surface side of the sample material, wherein the surface of the mask layer is irradiated with an electron beam, and at least part of the mask layer is exposed and refined.

43. The surface refining method as disclosed in claim 42, wherein the mask layer is made of SOG.

44. The surface refining method as disclosed in claim 42, wherein the mask layer is made of silicone rubber.

45. The surface refining method as disclosed in claim 42, wherein the electron beam is irradiated towards the laminated body, and the depth of a refined portion of the mask layer can be controlled by adjusting potential on the laminated body side.

46. The surface refining method as disclosed in claim 42, wherein the depth of the refined portion of the mask layer can be controlled by regulating the electron beam dosage.

47. The surface refining method as disclosed in claim 42, wherein an intermediate layer is positioned between the sample material and the mask layer.

48. The surface refining method as disclosed in claim 42, wherein a further mask layer is laminated onto a surface of the mask layer after refining the mask layer.

49. The surface refining method as disclosed in claim 48, wherein after laminating the further mask layer onto the surface of the mask layer, the surface of the further mask layer is irradiated with an electron beam, and at least part of the further mask layer is exposed and refined.

50. The surface processing method of claim 2, wherein an accelerating voltage for the electron beam is changed according to an irradiation position of the electron beam.

51. The surface processing method of claim 6, wherein the etchant is an etchant corroding the intermediate layer and/or the sample material more easily than the SOG layer.

52. The surface processing method as disclosed in claim 6, wherein the sample material is any of diamond, SiC, quartz, and resin.

53. The surface processing method as disclosed in claim 2, wherein the surface formed by the processing method can be used as a mold for use in molding.

54. The surface processing method as disclosed in claim 6, wherein the surface formed by the processing method can be used as a mold for use in molding.

55. A molded article wherein forming takes place using a surface processed using the method disclosed in claim 2.

56. A molded article wherein forming takes place using a surface processed using the method disclosed in claim 6.

57. The surface processing method of claim 26, further comprising a step of:
(c) eliminating remaining SOG layer after step (b).

58. The surface processing method of claim 2, wherein applied voltage in the vicinity of the surface is changed according to an irradiation position of the electron beam.

59. The surface processing method as disclosed in claim 2, wherein depth of the portion eliminated by etching is controlled based on electron beam dosage.

60. The surface processing method as disclosed in claim 2, wherein a silicone rubber layer is used in place of the SOG layer.
